(19) United States
(12) Patent Application Publication
(10) Pub. No.: US 2018/0074824 A1
(43) Pub. Date: Mar. 15, 2018

(54) Outer Product Engine

(71) Applicant: Apple Inc., Cupertino, CA (US)

(72) Inventors: Ali Sazegari, Los Altos, CA (US); Eric Bainville, Sunnyvale, CA (US); Jeffry E. Gonion, Campbell, CA (US); Gerard R. Williams, III, Los Altos, CA (US); Andrew J. Beaumont-Smith, Newton, MA (US)

(21) Appl. No.: 15/264,002

(22) Filed: Sep. 13, 2016

(51) Int. Cl. G06F 9/30; G06F 9/38

(52) U.S. Cl. CPC G06F 9/30101; G06F 9/3001; G06F 9/30043; G06F 9/3802

(57) ABSTRACT

In an embodiment, an outer product engine is configured to perform outer product operations. The outer product engine may perform numerous multiplication operations in parallel on input vectors, in an embodiment, generating a resulting outer product matrix. In an embodiment, the outer product engine may be configured to accumulate results in a result matrix, performing fused multiply add (FMA) operations to produce the outer product elements (multiply) and to accumulate the outer product elements with previous elements from the result matrix memory (add). A processor may fetch outer product instructions, and may transmit the instructions to the outer product engine when the instructions become non-speculative in an embodiment. The processor may be configured to retire the outer product instructions responsive to transmitting them to the outer product engine.

### BACKGROUND

### Technical Field

Embodiments described herein are related to circuitry to perform outer product operations in processor-based systems.

### Description of the Related Art

A variety of workloads being performed in modern computing systems rely on massive amounts of matrix multiplications, and particularly outer product operations. The outer product operation is the matrix result of two input vectors (X and Y), where each element (i, j) of the matrix is the product of element i of the vector X and element j of the vector Y: Mᵢⱼ=XᵢYⱼ. Outer product operations pertain to many types of workloads: neural networks, other machine learning algorithms, discrete cosine transforms (DCTs), convolutions of various types (one dimensional, two dimensional, multilayered two dimensional, etc.), etc. The performance of such operations on a general purpose central processing unit (CPU), even a CPU with vector instructions, is very low; while the power consumption is very high. Low performance, high power workloads are problematic for any computing system, but are especially problematic for battery-powered systems.

### SUMMARY

In an embodiment, an outer product engine is configured to perform outer product operations. The outer product engine may perform numerous multiplication operations in parallel, in an embodiment. More particularly, the outer product engine may be configured to perform numerous multiplication operations in parallel on input vectors, generating a resulting outer product matrix. In an embodiment, the outer product engine may be configured to accumulate results in a result matrix, performing fused multiply add (FMA) operations to produce the outer product elements (multiply) and to accumulate the outer product elements with previous elements from the result matrix memory (add). Other instructions may perform the accumulation as a subtraction. The outer product engine may be both high performance and power efficient, in an embodiment.

A processor may fetch outer product instructions, and may transmit the instructions to the outer product engine when the instructions become non-speculative in an embodiment. The processor may be configured to retire the outer product instructions responsive to transmitting them to the outer product engine. In an embodiment, the operand storage in the outer product engine may exceed the capacity of the register file in the processor. For example, the operand storage in the outer product engine may exceed the capacity of the register file in the processor by one or more orders of magnitude.

### BRIEF DESCRIPTION OF THE DRAWINGS

The following detailed description makes reference to the accompanying drawings, which are now briefly described.

FIG. 1 is a block diagram of one embodiment of a processor, an outer product engine, and a lower level cache.

FIG. 2 is a block diagram illustrating one embodiment of X, Y, and Z memories for the outer product engine shown in FIG. 1.

FIG. 3 is a block diagram illustrating one embodiment of X, Y, and Z memories for the outer product engine shown in FIG. 1 using a different size operand.

FIG. 4 is a timing diagram illustrating issuance of a fused multiply-add outer product operation to the outer product engine, for one embodiment.

FIG. 5 is a timing diagram illustrating issuance of a load/store operation to the outer product engine, for one embodiment.

FIG. 6 is table of instructions which may be used for one embodiment of the processor and outer product engine.

FIG. 7 is a block diagram of one embodiment of a system.

FIG. 8 is a block diagram of one embodiment of a computer accessible storage medium.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “clock circuit configured to generate an output clock signal” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible. In general, the circuitry that forms the structure corresponding to “configured to” may include hardware circuits. The hardware circuits may include any combination of combinatorial logic circuitry, clocked storage devices such as flops, registers, latches, etc., finite state machines, memory such as static random to access memory or embedded dynamic random access memory, custom designed circuitry, analog circuitry, programmable logic arrays, etc. Similarly, various units/circuits/components may be described as performing a task or tasks, for convenience in the description. Such descriptions should be interpreted as including the phrase “configured to.”

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims a unit/circuit/component or other structure that is configured to perform one or more tasks is expressly intended not to invoke 35 U.S.C. § 112(f) interpretation for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In an embodiment, hardware circuits in accordance with this disclosure may be implemented by coding the description of the circuit in a hardware description language (HDL) such as Verilog or VHDL. The HDL description may be synthesized against a library of cells designed for a given integrated circuit fabrication technology, and may be modified for timing, power, and other reasons to result in a final design database that may be transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and may further include other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA.

As used herein, the term “based on” or “dependent on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

### DETAILED DESCRIPTION OF EMBODIMENTS

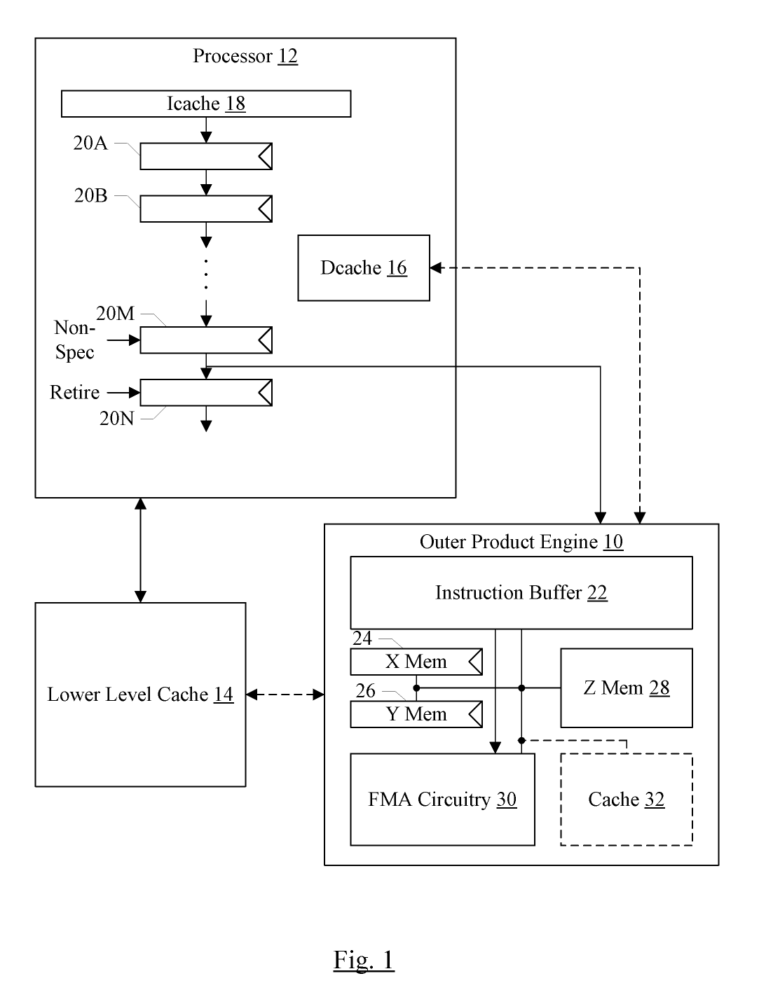

Turning now to FIG. 1, a block diagram of one embodiment of an apparatus including a processor 12, an outer product engine 10, and a lower level cache 14 is shown. In the illustrated embodiment, the processor 12 is coupled to the lower level cache 14 and the outer product engine 10. In some embodiments, the outer product engine 10 may be coupled to the lower level cache 14 as well, and/or may be coupled to a data cache (DCache) 16 in the processor 12. The processor 12 may further include an instruction cache (ICache) 18, one or more pipeline stages 20A-20N. The pipeline stages 20A-20N may be coupled in series. The outer product engine 10 may include an instruction buffer 22, an X memory 24, a Y memory 26, a Z memory 28, and a fused multiply-add (FMA) circuit 30 coupled to each other. In some embodiments, the outer product engine 10 may include a cache 32.

The outer product engine 10 may be configured to perform outer product operations. Specifically, input vectors may be loaded into the X memory 24 and the Y memory 26, and an outer product instruction may be transmitted to the outer product engine 10 by the processor 12. In response to the outer product instruction, the outer product engine 10 may perform the outer product operation and write the resulting outer product matrix to the Z memory 28. If the vector loaded into the X memory 24 (“X vector”) has a first number of vector elements and the vector loaded into the Y memory 26 (“Y vector”) has a second number of vector elements, the resulting matrix is a [first number]×[second number] matrix, where each entry (or element) in the matrix (element i, j) is the product of corresponding vector elements X(i) and Y(j). In an embodiment, the first number and second number are equal and the matrix is a square matrix. Other embodiments may implement non-square matrices, or different outer product operations may produce square or non-square results based on the input vector elements.

In an embodiment, the outer product engine 10 may perform outer product operations along with accumulating the result matrix with previous results in the Z memory 28 (where the accumulation may be adding or subtracting). That is, the outer product instruction may be a fused multiply-add (FMA) operation defined to multiply elements of the X vector by elements of the Y vector and add the products to corresponding elements of the Z matrix, or a fused multiply-subtract (FMS) operation defined to multiply elements of the X vector by elements of the Y vector and subtract the products from corresponding elements of the Z matrix. Alternatively, the FMS operation may include subtracting the corresponding elements of the Z matrix from the products. The remainder of this disclosure will generally describe the FMA operation, but the FMS operation may also be supported in a similar fashion.

The outer product engine 10 includes the FMA circuitry 30 to perform the FMA operations. In an embodiment, the FMA circuitry 30 may be an array of FMA circuits configured to operate on vector/matrix elements in parallel. In one implementation, the FMA circuits may include enough independent FMA circuits to process all of the X and Y vector elements in parallel. In another implementation, the FMA circuits may be sufficient to perform the FMA operation on a portion of the vector elements in parallel, and several cycles of operation may be used to complete the outer product instruction. A given FMA circuit in the array may be pipelined over multiple cycles, if desired, or may complete the FMA operation in one cycle. It is noted that the FMA circuitry 30 may also perform FMS operations by negating the subtrahend operand of the FMS.

The outer product engine 10 may offload the computationally-intensive outer product operations from the processor 12, which may be a general purpose CPU, for example. The outer product engine 10 may be more efficient at performing the outer product operations than a general purpose CPU, and may be higher performance than the general purpose CPU as well. The general purpose CPU is generally optimized for scalar integer and/or scalar floating point performance. Some CPUs may implement vector integer and/or vector floating point operations as well, but the memories 24, 26, and 28 and the outer product instruction may be defined to operate on operands that are much larger than registers/register files in the general purpose CPU, in some embodiments. For example, a vector instruction set for a CPU may be defined to operate on vectors of on the order of 4 or 8 elements, and may include on the order of 32 vector registers. On the other hand, an outer product instruction may be defined to operate on vectors that have one or more orders of magnitude more elements, and the Z memory 28 may have one or more orders of magnitude of result locations as well. For example, in various embodiments, vectors of up to 128, 256, or 512 total bits may be supported for an outer product instruction. The vectors may include, for example, 16, 32, or 64 vector elements in the bits included in a given vector. In an embodiment, a vector element may be a floating point number, although embodiments employing integer vectors elements may be used as well. Larger or smaller sized vectors and/or larger or smaller numbers of vector elements per vector may be supported. The result matrix may have a number of matrix elements equal to the square of the number of vector elements. For example, the result matrix in the Z memory 28 may have 16×16 result elements (or 256 result elements) if 16 element vectors are used. Other numbers of vector elements may lead to larger or smaller numbers of result elements in the Z memory 28. Generally, the number of elements in the result matrix of a given operation may be the product of the number of vector elements in the input vectors.

In an embodiment, the outer product engine may support multiple sizes of vector elements and outer product result elements. The maximum number of vector elements may correspond to a minimum size of the supported vector element sizes, and the number of vector elements for other sizes may be the maximum number multiplied by the ratio of the minimum size to that other size. When a larger size vector element is used, fewer products may be created since there are fewer vector elements in the X memory 24 and Y memory 26. The Z memory 28 may be arranged to write the elements in certain rows of the memory, leaving other rows unused. For example, if the vector elements are twice as large as the minimum-sized element, every other row in the Z memory 28 may be unused. If the vector elements are 4 times as large as the minimum size element, every fourth row may be used, etc.

In an embodiment, the outer product instructions executed by the outer product engine 10 may also include memory instructions (e.g. load/store instructions). The load instructions may transfer vectors from a system memory (not shown) to the X memory 24 and Y Memory 26, or matrix elements into the Z memory 28. The store instructions may write the matrix elements from the Z memory 28 to the system memory. Other embodiments may also include store instructions to write elements from the X and Y memories 24 and 26 to system memory. The system memory may be a memory accessed at a bottom of the cache hierarchy that includes the caches 14, 16, and 18. The system memory may be formed from a random access memory (RAM) such as various types of dynamic RAM (DRAM) or static RAM (SRAM). A memory controller may be included to interface to the system memory. In an embodiment, the outer product engine 10 may be cache coherent with the processor 12. In an embodiment, the outer product engine 10 may have access to the data cache 16 to read/write data. Alternatively, the outer product engine 10 may have access to the lower level cache 14 instead, and the lower level cache 14 may ensure cache coherency with the data cache 16. In yet another alternative, the outer product engine 10 may have access to the memory system, and a coherence point in the memory system may ensure the coherency of the accesses. In yet another alternative, the outer product engine 10 may have access to the caches 14 and 16.

In some embodiments, the outer product engine 10 may include a cache 32 to store data recently accessed by the outer product engine 10. The choice of whether or not to include cache 32 may be based on the effective latency experienced by the outer product 10 and the desired level of performance for the outer product engine 10. The cache 32 may have any capacity, cache line size, and configuration (e.g. set associative, direct mapped, etc.).

In the illustrated embodiment, the processor 12 is responsible for fetching the outer product instructions (e.g. FMA instructions, memory instructions, etc.) and transmitting the outer product instructions to the outer product engine 10 for execution. The overhead of the “front end” of the processor 12 fetching, decoding, etc. the outer product instructions may be amortized over the outer product operations performed by the outer product engine 10. In one embodiment, the processor 12 may be configured to propagate the outer product instruction down the pipeline (illustrated generally in FIG. 1 as stages 20A-20N) to the point at which the outer product instruction becomes non-speculative. In FIG. 1, the stage 20M illustrates the non-speculative stage of the pipeline. From the non-speculative stage, the instruction may be transmitted to the outer product engine 10. The processor 12 may then retire the instruction (stage 20N). Particularly, the processor 12 may retire the instruction prior to the outer product engine 10 completing the outer product operation (or even prior to starting the outer product operation, if the outer product instruction is queued behind other instructions in the instruction buffer 22).

Generally, an instruction may be non-speculative if it is known that the instruction is going to complete execution without exception/interrupt. Thus, an instruction may be non-speculative once prior instructions (in program order) have been processed to the point that the prior instructions are known to not cause exceptions/speculative flushes in the processor 12 and the instruction itself is also known not to cause an exception/speculative flush. Some instructions may be known not to cause exceptions based on the instruction set architecture implemented by the processor 12 and may also not cause speculative flushes. Once the other prior instructions have been determined to be exception-free and flush-free, such instructions are also exception-free and flush-free.

In the case of memory instructions that are to be transmitted to the outer product engine 10, the processing in the processor 12 may include translating the virtual address of the memory operation to a physical address (including performing any protection checks and ensuring that the memory instruction has a valid translation).

FIG. 1 illustrates a communication path between the processor 12 (specifically the non-speculative stage 20M) and the outer product engine 10. The path may be a dedicated communication path, for example if the outer product engine 10 is physically located near the processor 12. The communication path may be shared with other communications, for example a packet-based communication system could be used to transmit memory requests to the system memory and instructions to the outer product engine 10. The communication path could also be through system memory, for example the outer product engine may have a pointer to a memory region into which the processor 12 may write outer product instructions.

The instruction buffer 22 may be provided to allow the outer product engine 10 to queue instructions while other instructions are being performed. In an embodiment, the instruction buffer 22 may be a first in, first out buffer (FIFO). That is, outer product instructions may be processed in program order. Other embodiments may implement other types of buffers.

The X memory 24 and the Y memory 26 may each be configured to store at least one vector as defined for the outer product instructions (e.g. 16, 32, 64, etc. elements at the minimum vector element size). Similarly, the Z memory 28 may be configured to store at least one outer product result matrix. In some embodiments, the X memory 24 and the Y memory 26 may be configured to store multiple vectors and/or the Z memory 28 may be configured to store multiple result matrices. Each vector/matrix may be stored in a different bank in the memories, and operands for a given instruction may be identified by bank number.

The processor 12 fetches instructions from the instruction cache (ICache) 18 and processes the instructions through the various pipeline stages 20A-20N. The pipeline is generalized, and may include any level of complexity and performance enhancing features in various embodiments. For example, the processor 12 may be superscalar and one or more pipeline stages may be configured to process multiple instructions at once. The pipeline may vary in length for different types of instructions (e.g. ALU instructions may have schedule, execute, and writeback stages while memory instructions may have schedule, address generation, translation/cache access, data forwarding, and miss processing stages). Stages may include branch prediction, register renaming, prefetching, etc.

Generally, there may be a point in the processing of each instruction at which the instruction becomes non-speculative. The pipeline stage 20M may represent this stage for outer product instructions, which are transmitted from the non-speculative stage to the outer product engine 10. The retirement stage 20N may represent the state at which a given instructions results are committed to architectural state and can no longer by “undone” by flushing the instruction or reissuing the instruction. The instruction itself exits the processor at the retirement stage, in terms of the presently-executing instructions (e.g. the instruction may still be stored in the instruction cache). Thus, in the illustrated embodiment, retirement of outer product instructions occurs when the instruction has been successfully transmitted to the outer product engine 10.

The instruction cache 18 and data cache (DCache) 16 may each be a cache having any desired capacity, cache line size, and configuration. Similarly, the lower level cache 14 may be any capacity, cache line size, and configuration. The lower level cache 14 may be any level in the cache hierarchy (e.g. the last level cache (LLC) for the processor 12, or any intermediate cache level).

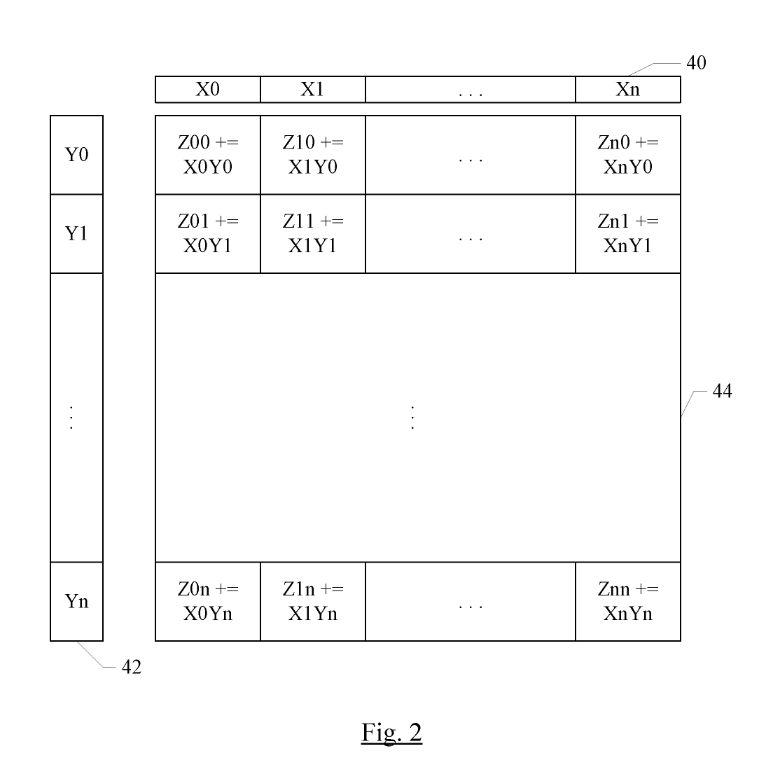

FIG. 2 is a block diagram illustrating vectors X and Y (reference numerals 40 and 42) and a result matrix 44. The X elements are labeled X0 to Xn, and the Y elements are labeled Y0 to Yn. The matrix elements are labeled Z00 to Znn, wherein the first digit is the X element number of the element that is included in the product and the second digit is the Y element number of the element that is included in the product. Thus, each row of the matrix 44 in FIG. 2 corresponds to a particular Y vector element. Each entry in the matrix 44 may be filled with an element when an FMA outer product instruction has been executed, summing the preceding value in the entry with the product of vector elements as shown (e.g. Z00+=X0Y0).

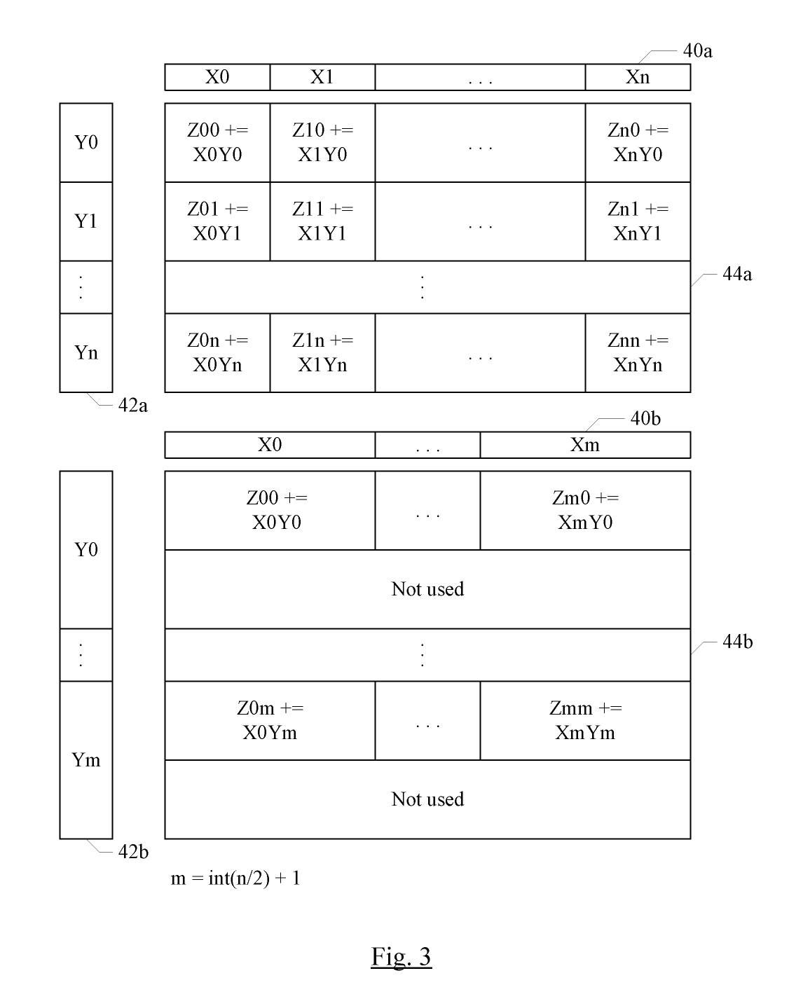

FIG. 3 illustrates two examples of the X and Y vectors 40 and 42 and the result matrix 44. In the first example, X and Y vectors 40a and 42a have elements 0 to N, which may be the minimum supported size of the vector element sizes. The results are thus filled in as Z00 to Znn, similar to the illustration of FIG. 2. In the second example, the X and Y vectors 40b and 42b have elements that are twice the minimum supported element size. Thus, the X and Y vectors have vector elements 0 to m, where m is the integer portion of n/2 plus one, as shown at the bottom of FIG. 3. The result matrix 44b has fewer values in it, because there are fewer products. In an embodiment, each other row in the result matrix 44b is not used when the vector elements are twice the minimum supported size. Even fewer rows would be used for vector elements that are four times the minimum, and still fewer as the size continues to increase.

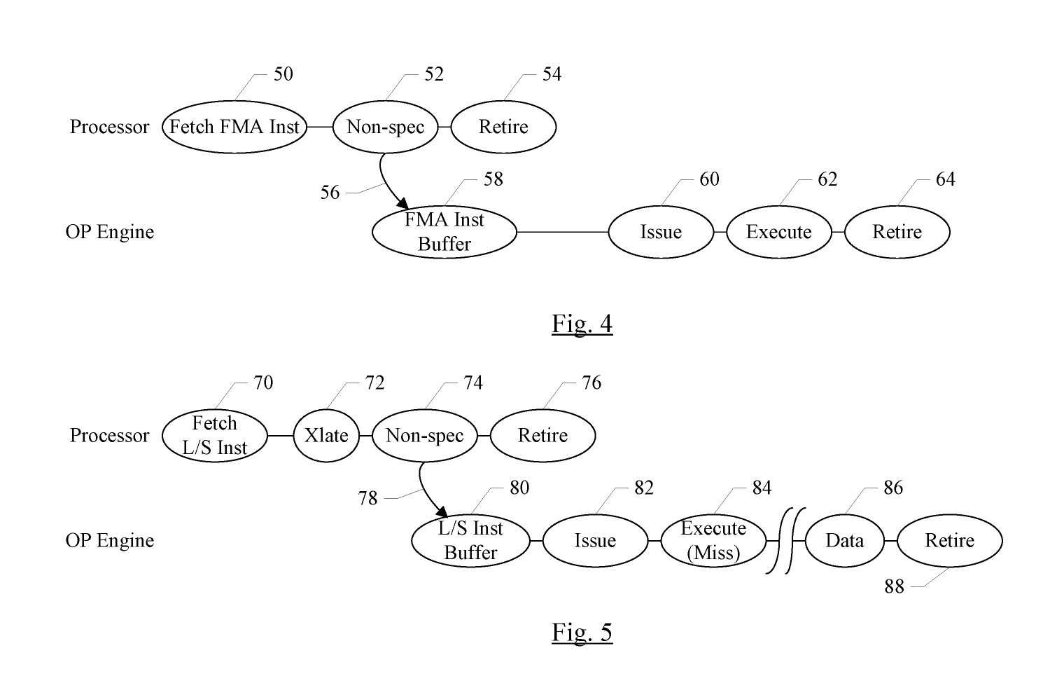

FIG. 4 is a timing diagram illustrating operation of one embodiment of an outer product FMA instruction being processed by the processor 12 and the outer product (OP) engine 10. Time increases in arbitrary units to the right in FIG. 4. Each operation illustrated in FIG. 4 may be performed over one or more clock cycles in the processor 12 and/or the outer product engine 10, and different operations in FIG. 4 may be performed over different numbers of clock cycles.

The processor 12 may fetch the FMA instruction (reference numeral 50) and process the instruction in the pipeline of the processor until it becomes non-speculative (reference numeral 52). The processor 12 may transmit the non-speculative FMA instruction to the outer product engine 10, which may enqueue the instruction in the instruction buffer 22 (arrow 56 and reference numeral 58). The processor 12 may retire the instruction (reference numeral 54). As mentioned previously, the processor 12 may retire the instruction prior to the instruction execution in the outer product engine 10.

The outer product engine 10 may issue the FMA instruction from the instruction buffer 22 for execution (reference numeral 60). The FMA circuitry 30 may execute the FMA operation, and the data may be written to the Z memory 28 and the instruction retired (reference numerals 62 and 64). While a space is shown between enqueueing the instruction in the instruction buffer 22 and the issue of the instruction (reference numerals 58 and 60) illustrating the passage of time, in some cases the instruction may be issued in response to being enqueued (e.g. if the buffer is empty). Some embodiments may support bypassing the buffer 22 if it is empty.

FIG. 5 is a timing diagram illustrating operation of one embodiment of an outer product memory instruction (load/store) being processed by the processor 12 and the outer product (OP) engine 10. Time increases in arbitrary units to the right in FIG. 5. Each operation illustrated in FIG. 5 may be performed over one or more clock cycles in the processor 12 and/or outer product engine 10, and different operations in FIG. 5 may be performed over different numbers of clock cycles.

Similar to the timing diagram of FIG. 4, the processor 12 may fetch the FMA instruction (reference numeral 70) and process the instruction in the pipeline of the processor until it becomes non-speculative (reference numeral 74). One of the operations performed by the processor 12, in the case of a memory operation, may be to translate a virtual address accessed by the memory operation (reference numeral 72). A translation may fail, causing an exception, e.g. if there is no mapping to a physical address or if the protection attributes of the translation do not permit the memory operation (such as a store to a read-only page). Assuming no exception occurs and the memory operation becomes non-speculative, the processor 12 may transmit the instruction to the outer product engine 10, which may enqueue the instruction in the instruction buffer 22 (arrow 78 and reference numeral 80). The processor 12 may retire the instruction (reference numeral 76). As mentioned previously, the processor 12 may retire the instruction prior to the instruction execution in the outer product engine 10.

The outer product engine 10 may issue the memory instruction from the instruction buffer 22 for execution (reference numeral 82). The outer product engine 10 may execute the memory operation, accessing the cache for the corresponding data. The cache or caches accessed may be different in different embodiments, as discussed above with regard to FIG. 1 (reference numeral 84). In the case illustrated in FIG. 5, a cache miss may occur for the operation. After experiencing the delay to fill the cache (illustrated by the break in FIG. 5, since the latency is generally large compared to instruction execution time), the data may be filled into the cache and, in the case of a load, written to the X memory 24, the Y memory 26, or the Z memory 28 (reference numeral 86). In the case of a store, the data may be written from the Z memory 28 to the cache. Accordingly, in the case of a cache miss, the latency may be borne by the outer product engine 10 while the processor 12 may continue ahead executing instructions. The outer product engine 10 may retire the instruction once the data has been filled/forwarded/written (reference numeral 88). A cache hit may be similar, except that the amount of time elapsing between execute and data (reference numerals 84 and 86) may be shorter (e.g. as short as zero, or they may occur in parallel).

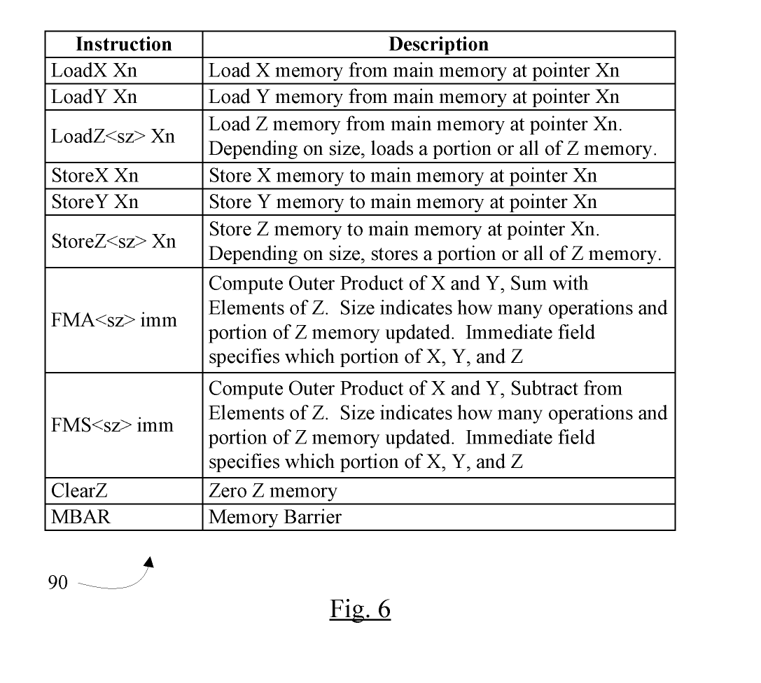

FIG. 6 is a table 90 illustrating an exemplary instruction set for one embodiment of the outer product engine 10. Other embodiments may implement any set of instructions, including subsets of the illustrated set, other instructions, a combination of subsets and other instructions, etc.

The memory operations may include load and store instructions. Specifically, in the illustrated embodiment, there are load and store instructions for the X, Y, and Z memories, respectively. In the case of the Z memory 28, a size parameter may indicate which vector element size is being used and thus which rows of the Z memory are written to memory (e.g. every other row, ever fourth row, etc.). In an embodiment, the X and Y memories may have multiple banks for storing different vectors. In such an embodiment, there may be multiple instructions to read/write the different banks or there may be an operand specifying the bank affected by the load/store X/Y instructions. In each case, and X memory bank may store a pointer to memory from/to which the load/store is performed. The pointer may be virtual, and may be translated by the processor 12 as discussed above. Alternatively, the pointer may be physical and may be provided by the processor 12 post-translation.

The FMA and FMS instructions may perform an outer product operation on the X and Y vectors and may either sum the resulting elements with the corresponding elements of the Z memory 28 (FMA) or subtract the result elements from the corresponding elements of the Z memory 28 (FMS). The size operand may specify the size of the vector elements, and this may implicitly specify which locations are updated. The immediate field of each instruction may specify which portion (bank) of the X, Y, and Z memories are affected.

In an embodiment, a Clear instruction may be provided to clear (zero) the Z memory, and a memory barrier (MBAR) instruction may provide a memory barrier operation. In an embodiment, the MBAR instruction may be used to ensure that subsequent processor memory operations (subsequent to the MBAR instruction in program order) occur after earlier outer product engine memory operations. The outer product engine 10 may treat the memory barrier as a full barrier. Prior outer product engine memory operations (in program order) complete prior to the MBAR, and subsequent outer product engine memory operations are not performed until the MBAR instruction completes. The processor 12 may treat the MBAR instruction as an acquire barrier. Subsequent (to the MBAR instruction in program order) memory operations from the processor wait unit the MBAR completes. Unlike other instructions performed by the outer product engine 10, the MBAR instruction may not be retired by the processor 12 until the outer product engine 10 signals completion.

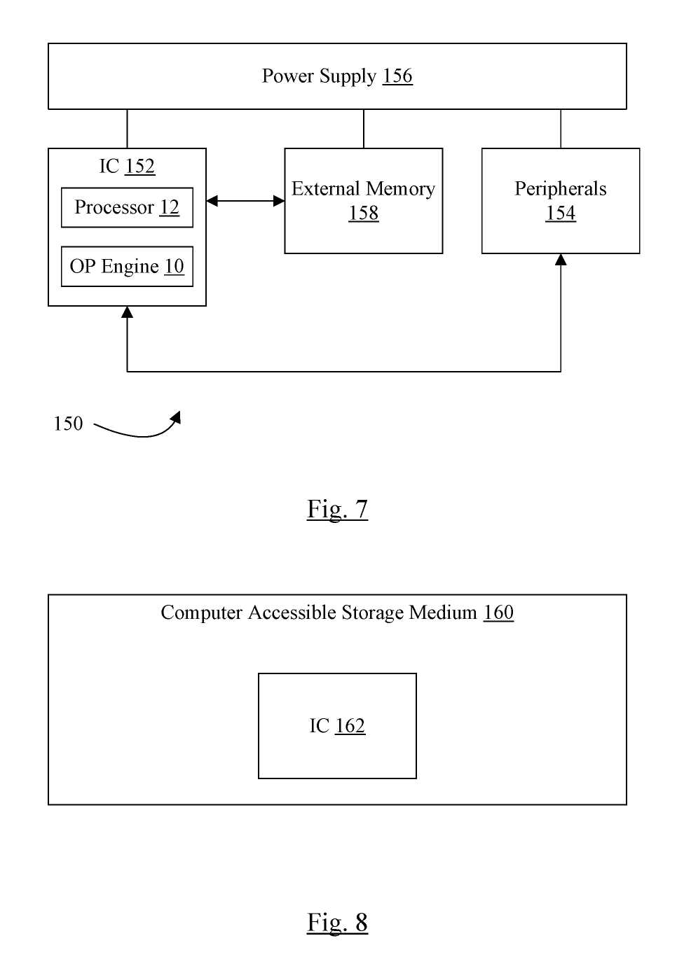

FIG. 7 is a block diagram of one embodiment of a system 150. In the illustrated embodiment, the system 150 includes at least one instance of an integrated circuit (IC) 152 coupled to one or more peripherals 154 and an external memory 158. A power supply 156 is provided which supplies the supply voltages to the IC 152 as well as one or more supply voltages to the memory 158 and/or the peripherals 154. The IC 152 may include one or more instances of the processor 12 and one or more instances of the outer product engine 10. In other embodiments, multiple ICs may be provided with instances of the processor 12 and/or the outer product engine 10 on them.

The peripherals 154 may include any desired circuitry, depending on the type of system 150. For example, in one embodiment, the system 150 may be a computing device (e.g., personal computer, laptop computer, etc.), a mobile device (e.g., personal digital assistant (PDA), smart phone, tablet, etc.), or an application specific computing device capable of benefitting from the outer product engine 10 (e.g., neural networks, convolutional neural networks (CNNs), other machine learning engines including devices that implement machine learning, etc.), In various embodiments of the system 150, the peripherals 154 may include devices for various types of wireless communication, such as wifi, Bluetooth, cellular, global positioning system, etc. The peripherals 154 may also include additional storage, including RAM storage, solid state storage, or disk storage. The peripherals 154 may include user interface devices such as a display screen, including touch display screens or multitouch display screens, keyboard or other input devices, microphones, speakers, etc. In other embodiments, the system 150 may be any type of computing system (e.g. desktop personal computer, laptop, workstation, net top etc.).

The external memory 158 may include any type of memory. For example, the external memory 158 may be SRAM, dynamic RAM (DRAM) such as synchronous DRAM (SDRAM), double data rate (DDR, DDR2, DDR3, etc.) SDRAM, RAIVIBUS DRAM, low power versions of the DDR DRAM (e.g. LPDDR, mDDR, etc.), etc. The external memory 158 may include one or more memory modules to which the memory devices are mounted, such as single inline memory modules (SIMMs), dual inline memory modules (DIMMs), etc. Alternatively, the external memory 158 may include one or more memory devices that are mounted on the IC 152 in a chip-on-chip or package-on-package implementation.

FIG. 8 is a block diagram of one embodiment of a computer accessible storage medium 160 storing an electronic description of the IC 152 (reference numeral 162) is shown. More particularly, the description may include at least the outer product engine 10 and the processor 12. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, or Flash memory. The storage media may be physically included within the computer to which the storage media provides instructions/data. Alternatively, the storage media may be connected to the computer. For example, the storage media may be connected to the computer over a network or wireless link, such as network attached storage. The storage media may be connected through a peripheral interface such as the Universal Serial Bus (USB). Generally, the computer accessible storage medium 160 may store data in a non-transitory manner, where non-transitory in this context may refer to not transmitting the instructions/data on a signal. For example, non-transitory storage may be volatile (and may lose the stored instructions/data in response to a power down) or non-volatile.

Generally, the electronic description 162 of the IC 152 stored on the computer accessible storage medium 160 may be a database which can be read by a program and used, directly or indirectly, to fabricate the hardware comprising the IC 152. For example, the description may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the IC 152. The netlist may then be placed and routed to produce a data set describing geometric shapes to be applied to masks. The masks may then be used in various semiconductor fabrication steps to produce a semiconductor circuit or circuits corresponding to the IC 152. Alternatively, the description 162 on the computer accessible storage medium 300 may be the netlist (with or without the synthesis library) or the data set, as desired.

While the computer accessible storage medium 160 stores a description 162 of the IC 152, other embodiments may store a description 162 of any portion of the IC 152, as desired (e.g. the outer product engine 10 and/or the processor 12, as mentioned above).

Numerous variations and modifications will become apparent to those skilled in the art once the above disclosure is fully appreciated. It is intended that the following claims be interpreted to embrace all such variations and modifications.

What is claimed is:

1. An apparatus comprising:
a processor configured to fetch an outer product instruction; and
an outer product engine coupled to the processor, wherein:
the outer product engine is configured to perform an outer product operation specified for the outer product instruction;
the outer product engine comprises at least two input memories configured to store input vectors for the outer product operation and an output memory configured to accumulate outer product results;
the processor is configured to retire the outer product instruction in response to transmitting the outer product operation to the outer product engine and prior to the outer product operation being completed by the outer product engine; and
a size of each input memory exceeds a size of vector registers in the processor.

2. The apparatus as recited in claim 1 wherein the processor is configured to transmit the outer product instruction to the outer product engine responsive to the outer product instruction becoming non-speculative in the processor.

3. The apparatus as recited in claim 2 wherein the outer product instruction comprises a load/store operation, and wherein the processor is configured to translate a virtual address of the load/store operation to a physical address prior to transmitting the outer product instruction to the outer product engine.

4. The apparatus as recited in claim 3 wherein, if the load/store operation misses in one or more caches to which the outer product engine has access, the latency of the cache miss is experienced in the outer product engine after the processor has retired the outer product instruction.

5. The apparatus as recited in claim 1 wherein the outer product instruction specifies a fused multiply-add operation, wherein the multiply portion of the fused multiply-add operation produces the outer product of the input vectors.

6. The apparatus as recited in claim 5 wherein the add portion of the fused multiply-add operation adds each element of the outer product to a corresponding element read from the output memory.

7. The apparatus as recited in claim 6 wherein outer product engine is configured to write the sum of each element and the corresponding element into the output memory.

8. The apparatus as recited in claim 1 wherein:
the outer product engine is configured to perform the outer product operation on a plurality of element sizes of the input vectors;
a first input memory of the input memories is sized to store a first number of elements of a minimum element size of the plurality of element sizes for a first input vector;
a second input memory of the input memories is sized to store a second number of elements of the minimum element size for a second input vector;
the output memory is sized to store a third number of elements that are results of the outer product operation of the first number of elements and the second number of elements, and the third number is the first number multiplied by the second number.

9. The apparatus as recited in claim 8 wherein the first number and the second number are equal.

10. The apparatus as recited in claim 8 wherein:
the first input memory is sized to store a fourth number of elements of a second element size of the plurality of element sizes and the fourth number is determined from the first number multiplied by a ratio of the minimum element size to the second element size;
the second input memory is sized to store a fifth number of elements of the second element size and the fifth number is determined from the second number multiplied by the ratio of the minimum element size to the second element size; and
the third memory stores a sixth number of elements that are results of the outer product operation on the fourth number of elements and the fifth number of elements during use, and a portion of the third memory is unused at the second element size.

11. An outer product engine comprising:
a circuit configured to perform an outer product operation on a first vector operand and a second vector operand, producing a resulting outer product matrix;
a first operand memory coupled to the circuit, wherein the first operand memory is sized to store a first number of elements of the first vector operand at a first element size and a second number of elements of the first vector operand at a second element size, wherein the second element size is larger than the first element size;
a second operand memory coupled to the circuit, wherein the second operand memory is sized to store a third number of elements of the second vector operand at the first element size and a fourth number of elements of the second vector operand at the second element size;
a third memory coupled to the circuit, wherein the third memory is sized to store the resulting outer product matrix for the outer product operation performed on the first element size, and wherein a portion of the third memory is unused for the outer product operation performed at the second element size.

12. The outer product engine is recited in claim 11 wherein the circuit is a fused multiply-add array, wherein a multiply portion of the fused multiply-add array is configured to perform a plurality of multiply operations on respective elements of the first operand and the second operand.

13. The outer product engine as recited in claim 12 wherein an add portion of the fused multiply-add array is further configured to add products of the plurality of multiply operations to respective data read from the third memory, and to write results of the addition to the third memory.

14. The outer product engine as recited in claim 12 wherein the multiply-add array is further configured to subtract products of plurality of multiply operations from respective data read from the third memory, and to write results of the subtraction to the third memory.

15. The outer product engine as recited in claim 11 further comprising an instruction buffer coupled the circuit and configured to store one or more outer product instructions received from a processor.

16. The outer product engine as recited in claim 15 wherein the instruction buffer is further configured to store load/store operations to read data to and write data from the first vector memory, the second vector memory, and the third memory.

17. An apparatus comprising:
a processor configured to fetch an outer product instruction; and
an outer product engine coupled to the processor, wherein:
the outer product engine is configured to perform an outer product operation specified for the outer product instruction;
the outer product engine comprises at least two input memories configured to store input vectors for the outer product operation and an output memory configured to accumulate outer product results; and
the outer product engine is configured to read the elements of the output memory and accumulate corresponding elements of the outer product operation with existing data in the output memory in response to the outer product instruction.

18. The apparatus as recited in claim 17 wherein the accumulation is addition.

19. The apparatus as recited in claim 17 wherein the accumulation is subtraction.

20. The apparatus as recited in claim 17 wherein the processor is configured transmit the outer product instruction to the outer product engine responsive to the outer product instruction becoming non-speculative in the processor.
